(19) United States
(12) Patent Application Publication
(10) Pub. No.: US 2010/0177035 A1
(43) Pub. Date: Jul. 15, 2010

(54) Mobile Computing Device With A Virtual Keyboard

(76) Inventors: Brian T. Schowengerdt, Seattle, WA (US); Phyllis Michaelides, Warwick, RI (US); Bruce J. Lynskey, Milbury, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/577,056

(22) Filed: Oct. 9, 2009

Related U.S. Application Data
(60) Provisional application No. 61/104,430, filed on Oct. 10, 2008.

(51) Int. Cl. G09G 5/00; H04N 7/18

(52) U.S. Cl. 345/156; 348/77

(57) ABSTRACT

The subject matter disclosed herein provides methods and apparatus, including computer program products, for mobile computing. In one aspect there is provided a system. The system may include a processor configured to generate at least one image including a virtual keyboard and a display configured to project the at least one image received from the processor. The at least one image of the virtual keyboard may include an indication representative of a finger selecting a key of the virtual keyboard. Related systems, apparatus, methods, and/or articles are also described.

### CROSS REFERENCE TO RELATED APPLICATION

This application claims the benefit under 35 U.S.C. §119(e) of the following provisional application, which is incorporated herein by reference in its entirety: U.S. Ser. No. 61/104,430, entitled “MOBILE COMPUTING DEVICE WITH A VIRTUAL KEYBOARD,” filed Oct. 10, 2008 (Attorney Docket No. 38745-501P01US).

### FIELD

This disclosure relates generally to computing.

### BACKGROUND

Mobile devices have become essential to conducting business, interacting socially, and keeping informed. By their very nature, mobile devices typically include small screens and small keyboards (or keypads). These small screens and keyboards make it difficult for a user of the mobile device to communicate when conducting business, interacting socially, and the like. However, a large screen and/or keyboard, although easier for viewing and typing, make the mobile device less appealing for mobile applications.

### SUMMARY

The subject matter disclosed herein provides methods and apparatus, including computer program products, for mobile computing.

In one aspect there is provided a system. The system may include a processor configured to generate at least one image including a virtual keyboard and a display configured to project the at least one image received from the processor. The at least one image of the virtual keyboard may include an indication representative of a finger selecting a key of the virtual keyboard.

In another aspect there is provided a method. The method including generating at least one image including a virtual keyboard; and providing the at least one image to a display, the at least one image comprising the virtual keyboard and an indication representative of a finger selecting a key of the virtual keyboard.

In another aspect there is provided a computer readable storage medium configured to provide, when executed by at least one processor, operations. The operations include generating at least one image including a virtual keyboard; and providing the at least one image to a display, the at least one image comprising the virtual keyboard and an indication representative of a finger selecting a key of the virtual keyboard.

Articles are also described that comprise a tangibly embodied machine-readable medium (also referred to as a computer-readable medium) embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 depicts a system 100 configured to generate a virtual keyboard and a virtual monitor;

FIG. 2 depicts a user typing on the virtual keyboard without a physical keyboard;

FIGS. 3A, 3B, 3C, 3D, and 4-12 depict examples of virtual keyboards viewed by a user wearing eyeglasses including microdisplays; and

FIG. 13 depicts a process 1300 for projecting an image of a virtual keyboard and/or a virtual monitor to a user wearing eyeglasses including microdisplays.

Like reference symbols in the various drawings indicate like elements.

### DETAILED DESCRIPTION

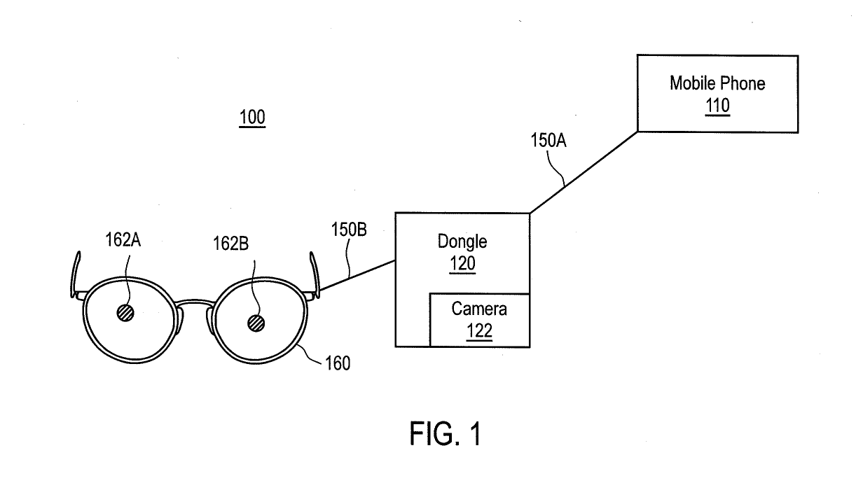

FIG. 1 depicts system 100, which includes a wireless device, such as mobile phone 110, a dongle 120, and microdisplays 162A-B, which are coupled to eyeglasses 160. The mobile phone 110, dongle 120, and microdisplays 162A-B are coupled by communication links 150A-B.

The system 100 may be implemented as a mobile computing system that provides a virtual keyboard and/or a virtual monitor, both of which are generated by the dongle 120 and presented (e.g., projected onto a user's eye(s)) via microdisplays 162A-B or presented via other peripheral display devices, such as a computer monitor, a high definition television (TV), and/or any other display mechanism. As used herein, the “user” refers to the user of the system 100. As used herein, projecting an image refers to at least one of projecting an image on to an eye or displaying an image, which can be viewed by an eye.

In some implementations, the system 100 has a form factor of a lightweight, pair of eyeglasses 160 attached by a communication link 150A (e.g., wire) to dongle 120. Moreover, the user typically wears eyeglasses 160 including microdisplays 162A-B. The system 100 may also include voice recognition and access to the Internet and other networks via mobile phone 110.

In some implementations, the system 100 has a form factor of the dongle 120 attached by a communication link 150A (e.g., wire, and the like) to a physical display device, such as microdisplays 162A-B, a computer monitor, a high definition TV, and the like.

The dongle 120 may include computing hardware, software, and firmware, and may connect to the user's mobile phone 110 via another communication link 150B. In some implementations, the dongle 120 is implemented as a so-called “docking station” for the mobile phone 110. The dongle 120 may be coupled to microdisplays 162A-B using communication link 150B, as described further below. The dongle 120 may also be coupled to display devices, such as a computer monitor or a high definition TV. In some implementations, the communication links 150A-B are implemented as a physical connection, such as a wired connection, although wireless links may be used as well.

The eyeglasses 160 and microdisplays 162A-B are implemented so that the wearer's (i.e., user's) field of vision is not monopolized. For example, the user may view a projection of the virtual keyboard and/or virtual monitor (which are projected by the microdisplays 162A-B) and continue to view other objects within the user' field of view. The eyeglasses 160 and microdisplays 162A-B may also be configured to not require backlighting and produce a relatively high-resolution output display.

Each of the lenses of the eyeglasses 162 may be configured to include one of the microdisplays 162A-B. The microdisplays 162A-B are each implemented to create a high-resolution image (e.g., of the virtual machine and/or virtual monitor) on the user's eyes. From the perspective of the user wearing the eyeglasses 160 and microdisplays 162A-B, the microdisplays 162A-B provide an image that is equivalent to what the user would see when viewing, for example, a typical 17-inch computer monitor viewed at typical viewing distances.

In some implementations, microdisplays 162A-B may project, when the user is ready to type or navigate to a Web site, a virtual keyboard positioned below the virtual monitor displayed to the user. In some implementations, rather than (or in addition to) projecting an image via the microdisplays 162A-B, an alternative display device (e.g., a computer monitor, a high definition TV, and the like) is used to display images (e.g., when the user is ready to type or navigate to a Web site, the alternative display device presents a virtual keyboard positioned below a virtual monitor displayed.)

The microdisplays 162A-B may be implemented as a chip. The microdisplays 162A-B may be implemented using complementary metal oxide semiconductor (CMOS) technology, which generates relatively small pixel pitches (e.g., down to 10 μm (micrometers) or less) and relatively high display resolutions. The microdisplays 162A-B may be used to project images to the eye (referred to as “near to the eye” (NTE) applications). To generate the image which is projected onto the eye, the microdisplays 162A-B may be implemented with one or more of the following technologies: electroluminescence, crystal on silicon (LCOS), organic light emitting diode (OLED), vacuum fluorescence (VF), reflective liquid crystal effects, tilting micro-mirrors, laser-based virtual retina displays (VRDs), and deforming micro-mirrors.

In some implementations, microdisplays 162A-B are each implemented using polymer organic light emitting diode (P-OLED) based microdisplay processors, which carry video images to the user's eyes. When this is the case, each of the microdisplays 162A-B on the eyeglasses 160 is covered by two tiny lenses, one to enlarge the size of the image projected on the user's eye and a second lens to focus the image on the user's eye. If the user already wears corrective eyeglasses, the microdisplays 162A-B may be affixed onto the user's eyeglasses 160. The image that is projected from the microdisplays 162A-B (and their lenses) produces a relatively high-resolution image (also referred to as a virtual image as well as video) on the user's eyes.

The dongle 120 may include a program for a Web browser, which is projected by the microdisplays 162A-B as a virtual image onto the user's eye (e.g., as part of the virtual monitor) or shown as an image on a display device (e.g., computer monitor, high definition TV, and the like). The dongle 120 may include at least one processor, such as a microprocessor. However, in some implementations, the dongle 120 may include two processors. The first processor of dongle 120 may be configured to provide one of more of the following functions: provide a Web browser; provide video feed to the microdisplay processors or to other external display devices; perform operating system functions; provide audio feed to the eyeglasses or head-mounted display; act as the conduit for the host modem; and the like. The second processor of dongle 120 may be configured to provide one of more of the following functions: detect finger movements and transform those movements into keyboard selections (e.g., key strokes of a qwerty keyboard, number pad strokes, and the like) and/or monitor selections (e.g., mouse clicks, menu selections, and the like on the virtual monitor); select the input template (keyboard or other input device template); process the algorithms that translate finger positions and movements into keystrokes; and the like.

Moreover, one or more of the first and second processors may perform one more of the following functions: run an operating system (e.g., Linux, maemo, Google Android, etc.); run Web browser software; provide two-dimensional graphics acceleration; provide three-dimensional graphics acceleration; handle communication with the host mobile phone; communicate to a network (e.g., a WiFi network, a cellular network, and the like); input/output from other hardware modules (e.g., external graphics controller, math coprocessor, memory modules, such as RAM, ROM, FLASH, storage, etc., camera(s), video capture chip, external keyboard, pointing device such as mouse, other peripherals, etc.); run image analysis algorithms to perform figure/ground separation; estimate fingertip location; detect keypresses; run image-warping software to take image of hands from camera viewpoint and warp image to simulate the viewpoint of the user's eyes; password management for accessing cloud computing data and other secure web data; and update its programs over the web. Furthermore, in some implementations, only a first processor is used to eliminate the second processor and its associated cost. In other implementations, operations from the first processor can be off-loaded (and/or shared as in a cluster). When that is the case, one or more of the following functions may be performed by the second processor: input/output from other hardware modules (e.g., a first processor, a math co-processor, memory modules, such as RAM, ROM, Flash, etc, camera(s), a video capture chip, etc.); run image analysis algorithms to perform figure/ground separation; estimate fingertip location, detect keypresses, etc.); run image-warping software to take image of hands from camera viewpoint; and warp an image to simulate the viewpoint of the user's eyes; and perform any of the aforementioned functions.

The dongle 120 may also include a camera 122. The camera 122 may be implemented as any type of camera, such as a CMOS image sensor or like device. Moreover, although dongle 120 is depicted separate from mobile phone 110, dongle 120 may be located in other location (e.g., implemented within the mobile phone 110).

Dongle 120 may generate an image of a virtual keyboard, which is projected via microdisplays 162A-B or is displayed on an external display device, such as a computer monitor or a high definition TV. The virtual keyboard is projected below the virtual monitor, which is also projected via microdisplays 162A-B. The virtual keyboard may also be displayed on an external display device for presentation (e.g., displaying, viewing, etc.). In some implementations, the virtual keyboard is projected by microdisplays 162A-B and/or displayed on an external display device to a user when the user places an object (e.g., a hand, finger, etc.) into the field of view of camera 122.

Moreover, outlined images of the users' hands (and/or fingers) may be superimposed on the virtual keyboard image projected via microdisplays 162A-B or displayed on an external display device. These superimposed hands and/or fingers may instantly allow the user to properly orient his or her hands, so that the user's hands and/or finger appear to be positioned over the virtual keyboard image. For example, the user may then move his or her fingers in a region imaged by the camera 122. The images are used to detect the position of the fingers and map the finger positions to corresponding positions on a virtual keyboard. The user is thus able to virtually type without an actual keyboard. Likewise, the user may virtually navigate using a browser (which is projected via microdisplays 162A-B or displayed on an external display device) and using the finger position detection (e.g., using image processing techniques, such as motion detectors, differentiators, etc.) provided by dongle 120.

In some implementations, the virtual keyboard image projected via microdisplays 162A-B (or displayed by the external display device) may retract when the users' hands are out of range of the camera 122. With a full sized virtual monitor and a virtual keyboard (both of which are projected by the microdisplays 162A-B on to the user's eye or shown on the external display device), virtual monitor and a virtual keyboard are provided to a user to enable a work environment that eliminates the need to tether the user to a physical keyboard or a physical monitor.

In some implementations, the dongle 120 may include one or more processors, software, firmware, camera 122, and a power source, such as a battery. Although dongle 120 may include a battery, in some implementations, system 100 may obtain power from the mobile phone 110 via communication link 150B (e.g., when communication link is implemented as a universal serial bus (USB)).

In one implementation, dongle 120 includes a mobile computing processor, such as Texas Instruments OMAP 3400 processor, Intel's Atom processor, or an ST Micro's 8000 series processor. The dongle 120 may also include another processor dedicated to processing inputs. For example, the second processor may be coupled to the camera to determine finger and/or hand positions and to transform those positions into, for example, keyboard strokes. The second processor (which is coupled to the camera) may read the positions and movements of the user's fingers, map these into keystrokes (or mouse positioning for navigation purposes), and send this information via communication link 150B to the microdisplays 162A-B, where an image of the detected finger position is projected to the user receiving the image of the virtual keyboard. The virtual keyboard image with the superimposed finger and hand positions provides feedback to the user. This feedback may be provided by, for example, having a key of the virtual keyboard change color as a feedback signal to assure the user of the correct keystroke choice. This feedback may also include an audible signal or other visual indications, so that the user hears an audible “click” when a keystroke occurs.

In some implementations, the dongle 120 may be configured with an operating system, such as a Linux-based operating system. Moreover, the dongle 120 operating system may be implemented independently of the operating system of mobile phone 110, allowing maximum flexibility and connectivity to a variety of mobile devices. Moreover, dongle 120 may utilize the mobile device 110 as a gateway connection to another network, such as the Web (or Internet).

The system 100 provides at microdisplay 162A-B or at the external display device (e.g., computer monitor, high definition TV, etc.) a standard (e.g., full) Web page for presentation via a Web browser (e.g., Mozilla, Firefox, Chrome, Internet Explorer, etc.), which is also displayed at microdisplay 162A-B or on the external display device. The dongle 120 may receive Web pages (as well as other content, such as images, video, audio, and the like) from the Web (e.g., a Web site or Web server providing content); process the received Web pages through one of the processors at the dongle 120 (e.g., a general processing unit included within the mobile computing processor); and transport the processed Web pages through communication link 150B and microdisplays 162A-B mounted on the eyeglasses 160 and/or transport the processed Web pages through communication link 150B to the external display device.

The user may navigate the Web using the Web browser projected by microdisplays 162A-B or shown on the external display device as he (or she) would from a physical desktop computer. Any online application can be accessed through the virtual monitor viewed via the microdisplays 162A-B or viewed on the external display device.

When the user is accessing email through the Web browser, the user may open, read, and edit email message attachments. This email function may be executed via software (which is configured in the dongle 120) that creates a path to a standard online email application to let the user open, read, and edit email message attachments.

The following description provides an implementation of the virtual keyboard, virtual monitor, and a virtual hand image. The virtual hand image provides feedback regarding where a user's fingers are located in space (i.e., a region being imaged by camera 122) with respect to the virtual keyboard projected by the microdisplays 162A-B or displayed on the external display device.

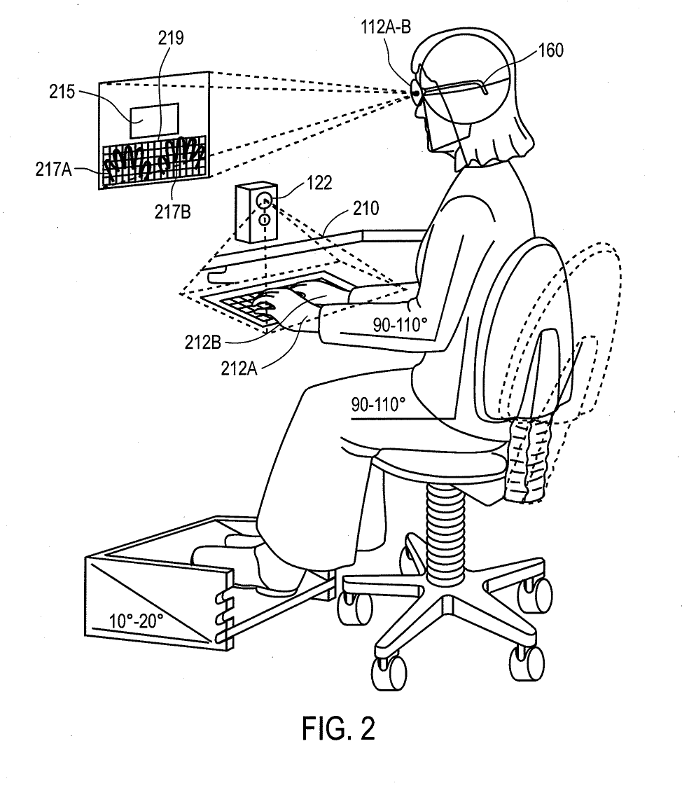

FIG. 2 depicts system 100 including camera 122, eyeglasses 160, and microdisplays 162A-B, although some of the components from FIG. 1 are not shown for to simplify the following description. The camera 122 may be place on a surface, such as a table. The camera 122 acquires images of a user typing in the field of view 210 of camera 122, without using a physical keyboard. The field of view 210 of camera 122 is depicted with the dashed lines, which bounds a region including the user' hands 212A-B. The microdisplays 162A-B project an image of virtual keyboard 219, which is superimposed over the virtual monitor 215. The microdisplays 162A-B may also project an outline of the user's hands 217A-B, which represents the current position of the user's hands. Moreover, the outline of the user's hands 217A-B is generated based on the image captured by camera 122 and processed by the processor at dongle 120. The user's finger positions are sensed using camera 122 incorporated into the dongle 120. The external display device may present an image of a virtual keyboard 219, which is superimposed over the virtual monitor 215. The external display device may also show an outline of the user's hands 217A-B, which represents the current position of the user's hands. Moreover, the outline of the user's hands 217A-B may be generated based on the image captured by camera 122 and processed by the processor at dongle 120. The user's finger positions are sensed using camera 122 incorporated into the dongle 120.

The camera 122 acquires images and provides (e.g., sends) those images to a processor in the dongle 120 for further processing. The field of view of the camera 122 includes the sensing region for the virtual keyboard, which can fill the entire field of view of microdisplays 162A-B (or fill the external display device), or fill a subset of that full field of view. The image processing at dongle 120 maps the virtual keys to regions (or areas) of the field of view 210 of the camera 122 (e.g., pixels 50-75 on lines 280-305 are mapped to the letter “A” on the virtual keyboard). In some embodiments, these mappings are fixed within the field of view of the camera, but in other embodiment may dynamically shift the key mapping (e.g., to accommodate different typing surfaces).

In an implementation, the field of view of the camera is subdivided into a two-dimensional array of adjacent rectangles, representing the locations of keys on a standard keyboard (e.g., one row of rectangles would map to “Q”, “W”, “E”, “R”, “T”, “Y”, . . . ). As an alternative, this mapping of sub-areas in the field of view of the camera can be re-mapped to a different set of rectangles (or other shapes) representing a different layout of keys. For example, the region-mapping can be shifting from a qwerty keyboard with number pad to a qwerty keyboard without a number pad, expanding the size of the letter keys to fill the space in the camera's field of view that the number pad formerly occupied. Alternatively, the camera field-of-view could be remapped to a huge number pad, without any qwerty letter keys (e.g., if the user is performing data entry). User's can download keyboard “skins” to match their typing needs and aesthetics (e.g., some users may want a minimalist keyboard skin with just the letters, no numbers, no arrow keys, and no function keys—maximizing the size of each key in the limited real estate of the camera field of view, while other users may want all the letter keys, arrow keys, but no function keys, and so forth).

When a user of system 100 places its hands in the sensing region 210 of the camera (e.g., within the region which can be imaged by camera 122), the camera 122 captures images, which include images of hands and/or fingers, and provides those images to a processor in the dongle 120. The processor at the dongle 120 may process the received images. This processing may include one or more of the following tasks. First, the processor at the dongle 120 detects any suspected key presses within region 210. A key press is detected when the user taps a finger against the surface (e.g., a table) that is mapped to a particular virtual key (e.g., the letter “A”). Second, the processor at the dongle 120 estimates the regions of the virtual keyboard over which the tips of the user's fingers are hovering. For example, when a user taps a region (or area), that region corresponds to a region in the image captured by camera 122.

Moreover, the finger position(s) captured in the image may be mapped to coordinates (e.g., an X and Y coordinate for each finger or a point in XYZ space) for each key of the keyboard. Next, the processor at the dongle 120 may distort the image of the user's hands (e.g., stretching, uniformly or non-uniformly, the image along one axis). This intentional distortion may be used to remap the camera's view of the hands (or fingertips) to approximate what the user's hands would look like from the point of view of the user's own eyes.

Regarding distortion, the basic issue is that the video-based tracking/detection of key presses tends to work best if the camera is in front of the hands, facing the user. The camera would show the fronts of the fingers and a bit of the foreshortened tops of the user's hands, with the table and the user's chest in the background of the image. In the virtual display, system 100 should give the user the impression that he or she is looking down at the tops of her hands. To accomplish this, system 100 rotates the image by 180 degrees (so the fingertips are at the top of the image), compresses the parts of the image that represent the tips of the fingers, and stretches the parts of the image that represent the upper knuckles, bases of the fingers, and the tops of the hands.

In some implementations, the dongle 120 and camera 122 may be placed on a surface (e.g., a table) with the camera 122 pointed at a region where the user will be typing without a physical keyboard. In some implementations, the camera 122 is placed adjacent to (e.g., on the opposite side of) the typing region, as depicted at FIG. 2. Alternatively, the camera 122 can be placed laterally (e.g., to the side of) the typing surface with the camera pointing towards the general direction of region where the user will be typing.

Although the user may utilize the camera 122 in other positions, which do not require the user to be seated or do not require a surface, the positioning depicted at FIG. 2 may, in some implementations, have several advantages. First, the camera 122 can be positioned in front of a user's hands, such that the camera 122 and dongle 120 can better detect (e.g., image and detect) the vertical displacement of the user's fingertips. Second, the keyboard sensing area (i.e., the field of view 210 of the camera 122) is stabilized (e.g., stabilized to the external environment (or world)). For example, when the camera 122 is stabilized, even as the user shifts position or head movement occurs, the keyboard-sensing region 210 within the field of view of camera 122 will remain in the same spot on the table. This stability improves the ability of the processor at the dongle 120 to detecting finger positions in the images generated by camera 122. Moreover, the positioning of FIG. 2 enables the use of a less robust processor (e.g., in terms of processing capability) at the dongle 120 and a less robust camera 122 (e.g., in terms of resolution), which reduces the cost and simplifies the design of system 100. Indeed, the positioning of FIG. 2 enables the dongle 120 to use the lower resolution cameras provided in most mobile phones.

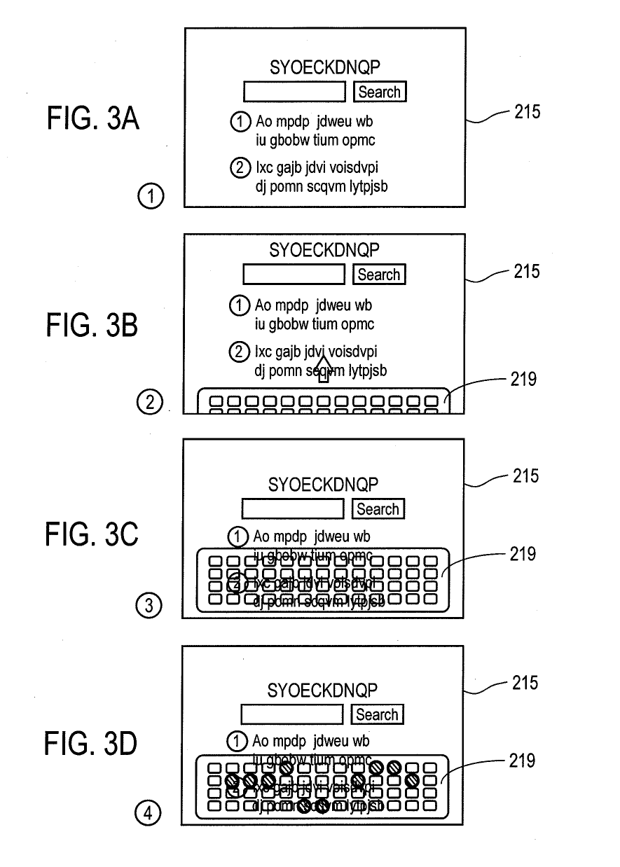

Rather than project an image onto the user's eye, the microdisplays 162A-B may project the virtual monitor (including, for example, a graphical user interface, such as a Web browser) and the virtual keyboard on a head-worn near-to-eye display also called a head-mounted display (HMD) mounted on eyeglasses 160. The view through the user's eyes (or alternatively projected on the user's eye) are depicted at FIGS. 3-12 (all of which are further described below). FIGS. 3-12 may also be presented by a displaying device, such as a monitor, high definition TV, and the like.

When a user would like to type information using the virtual keyboard, the user may trigger (e.g., by moving a hand or an object in front of camera 122) an image of the virtual keyboard 219 to appear at the bottom of the view generated by the microdisplays 162A-B or generated by the external display device.

FIG. 3A depicts virtual monitor 215 (which is generated by microdisplays 162A-B). FIGS. 3B-D depict the image of the virtual keyboard 219 sliding into the user's view. The triggering of the virtual keyboard 219 may be implemented in a variety of ways. For example, the user may place a hand within the field of view 210 of camera 122 (e.g., the camera's sensing region). In this case, the detection of fingers by the dongle 120 may trigger the virtual keyboard 219 to slide into view, as depicted in FIGS. 3B-D. In another implementation, the user presses a button on system 100 to deploy the virtual keyboard 219. In another implementation, the user gives a verbal command (which is recognized by system 100). The voice command is detected (e.g., parsed) by a speech recognition mechanism in system 100 to deploy the virtual keyboard 219.

The image of the virtual keyboard 219 may take a variety of forms. For example, the virtual keyboard 219 may be configured as a line-drawing, in which the edges of each key (e.g., the letter “A”) is outlined by lines visible to the user and the outline of the virtual keyboard image 219 is superimposed over the lower half of the virtual monitor 215, such that the user can see through the transparent portions of the virtual keyboard 219. In other implementations, the virtual keyboard 219 is rendered by microdisplays 162A-B as a translucent image, allowing a percentage of the underlying computer view to be seen through the virtual keyboard 219.

As described above, as the user moves his or her fingers over the camera's field of view 210, the dongle 120 (or a processor therein) detects from the images provided by camera 122 the position of the fingers relative to regions (within the field of view 210) mapped to each key of the keyboard, generates a virtual keyboard 219, and detects positions of the finger tips, which is used to generate feedback in the form of virtual fingers 217A-B (e.g., an image of the position of the finger tip as captured by camera 122, processed by the dongle 120, and projected as an image by the microdisplays 162A-B).

of FIGS. 3D-12. The virtual fingers are virtual in the sense that the virtual fingers do not constitute actual fingers but rather an image of the fingers. The virtual keyboard is also virtual in the sense that the virtual keyboard does not constitute a physical keyboard but rather an image of a keyboard. Likewise, the virtual monitor is virtual in the sense that the virtual monitor does not constitute a physical monitor but rather an image of a monitor.

Referring to FIG. 3D, finger positions are depicted as translucent oval outlines centered on the position of each finger. As the user moves his or her fingertips over the virtual keyboard 219 generated by microdisplays 162A-B, the rendered images represent the fingertips as those fingertips type.

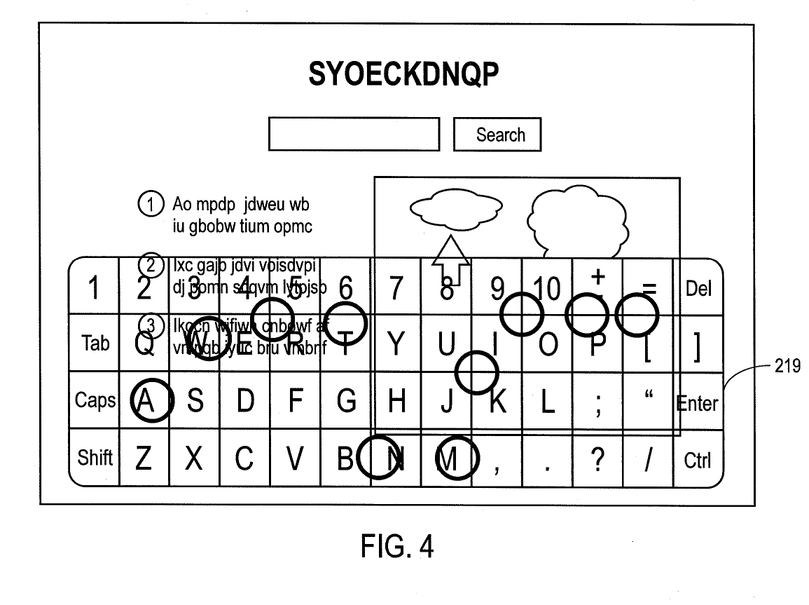

Referring to FIG. 4, virtual keyboard 219 includes translucent oval outlines, which are centered on the position of each finger as detected by the camera 122 and dongle 120 as the user types using the virtual keyboard.

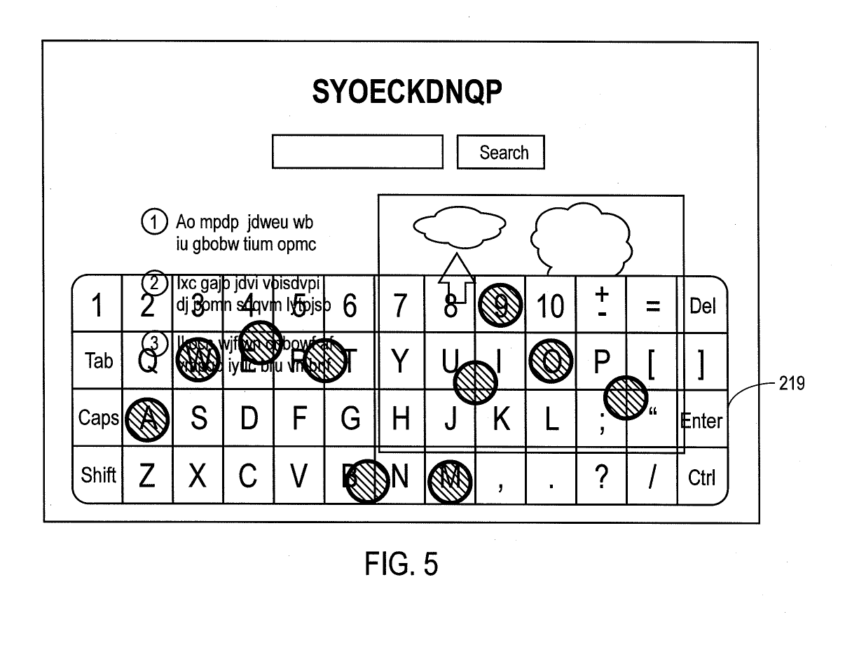

Referring to FIG. 5, virtual keyboard 219 includes translucent solid ovals, which are centered on the position of each finger as detected by the camera 122 and dongle 120 as the user types using the virtual keyboard.

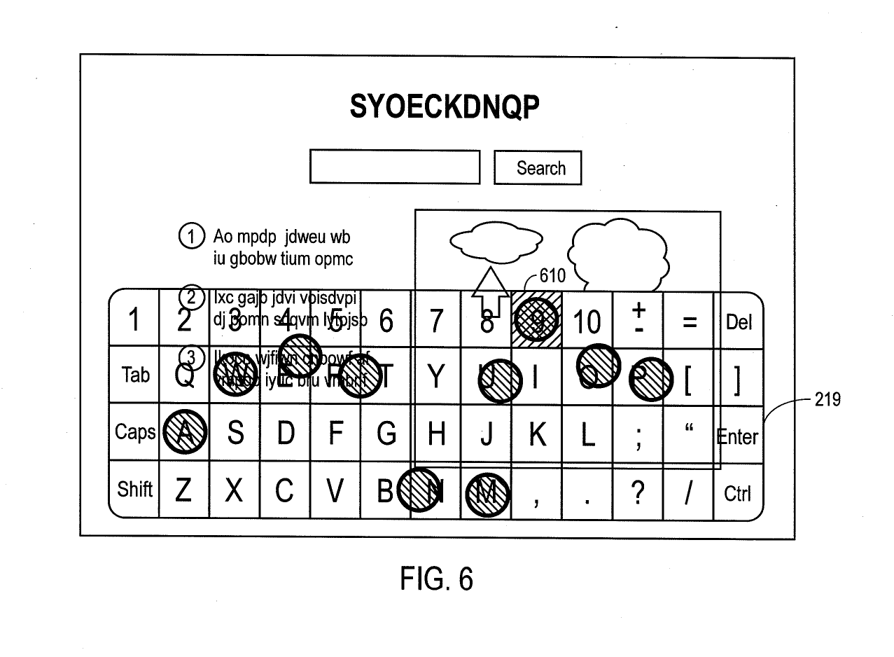

FIG. 6 represents fingertip position's using the same means as that of FIG. 5, but adds a representation of a key press illuminated with a color 610 (e.g., a line pattern, a cross hatch pattern, etc.). In the example of FIG. 6, when a user taps a surface within field of view 210 of camera 122 and that tap corresponds to a region that has been mapped by dongle 120 to the number key “9” (e.g., the coordinates of that tap on the image map to the key “9”), the image of the number “9” key in the virtual keyboard 219 is briefly illuminated with a color 610 (e.g., a transparent yellow color, cross hatch, increase brightness, decrease brightness, shading, a line pattern, a cross hatch pattern, etc.) to indicate to the user that the system 100 has detected the intended key press.

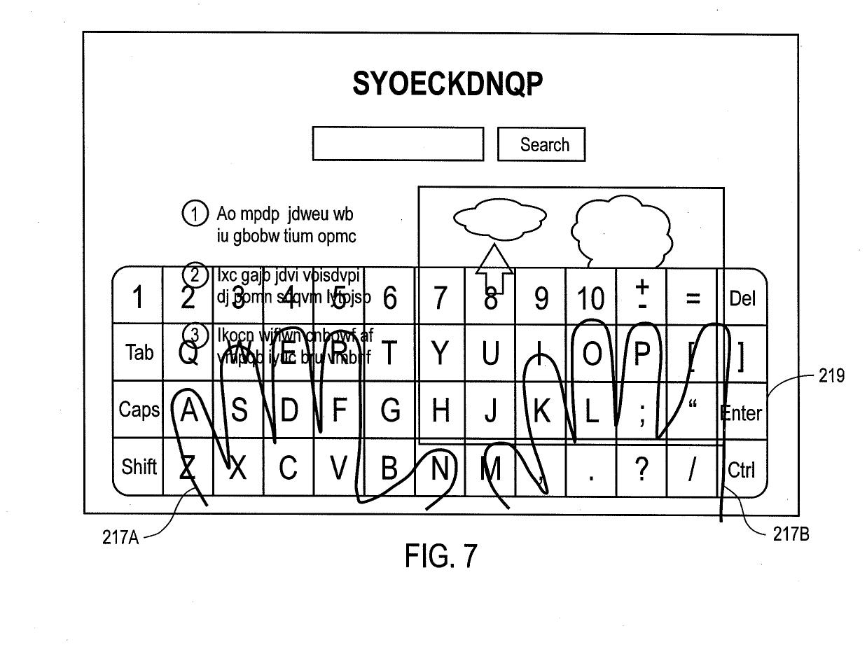

Referring to FIG. 7, an outline image of the user's hands and fingers 217A-B is superimposed over the virtual keyboard image 219. This hand outline 217A-B may be generated using a number of methods. For example, in one process, an image processor included in the dongle 120 receives the image of the user's hands captured by the camera 122, subtracts the background (e.g., the table surface) from the image, and uses an edge detection filter to create a silhouette line image of the hand (including the fingers), which is then projected (or displayed) by microdisplays 162A-B. In addition, the image processor of dongle 120 may distort the captured image of the hands, such that the image of the hands better matches what they would look like from the point of view of the user's eyes. The line image of the hands 217A-B is not a filtered version of a captured image. The term “filtering” refers primarily to the warping (i.e., distortion) noted above. For example, system 100 may render some generic fake hands based solely on fingertip locations (not directly using any captured video data in the construction of the hand image) Instead, it is a generic line image of hands 217A-B rendered by the processor, mapped to the image of the keyboard, using the detected fingertip positions as landmarks.

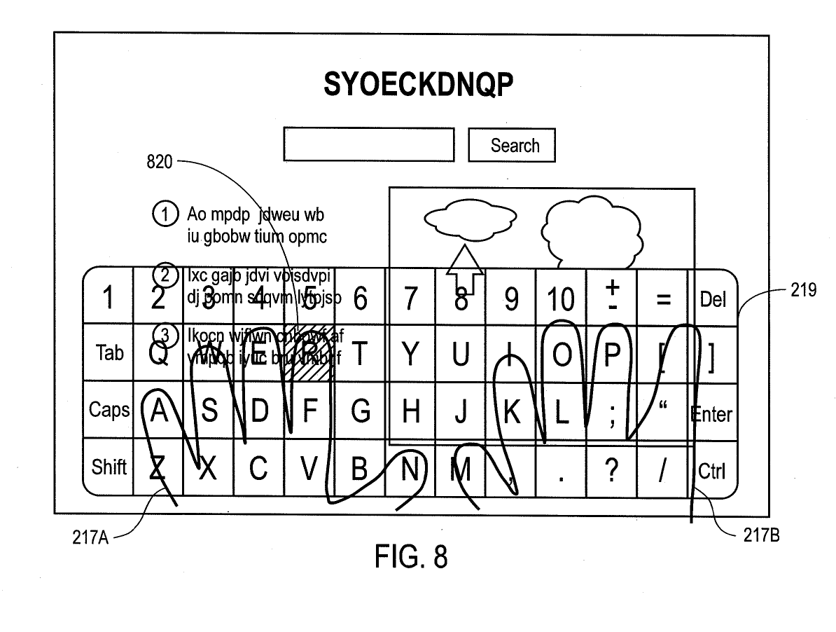

FIG. 8 depicts is similar to FIG. 7, but adds the display of a key press illuminated by a color 820. In this example, when the user taps within the field of view 210 of camera 122 (where the region tapped by the user has been mapped to the key “R”), the image of the “R” key press 820 of the virtual keyboard 219 is visually indicated (e.g., briefly illuminated with a transparent color) to signal to the user that the system 100 has detected the intended key press.

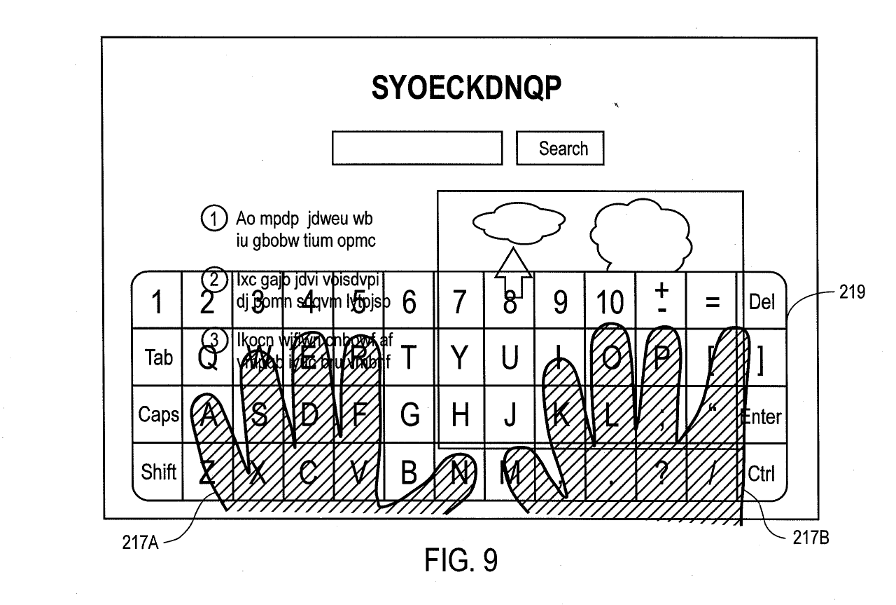

FIG. 9 is similar to FIG. 7 in that it represents the full hands 217A-B of the user on the virtual keyboard image 219, but a solid image of the virtual hands 217A-B is used rather than a line image of the hands. This solid image may be translucent or opaque, and may be a photo-realistic image of the hands, a cartoon image of the hand, or a solid-filled silhouette of the hands.

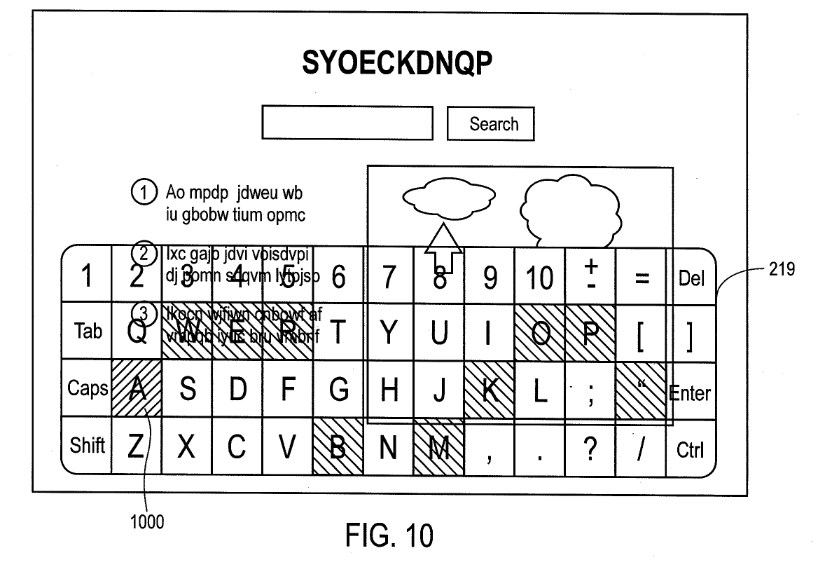

Referring to FIG. 10, when a fingertip is located over a region mapped to a key of the virtual keyboard 219, the keys of the virtual key board are illuminated. For example, when the dongle 120 detects that a fingertip is over a key of the virtual keyboard 219, that key is illuminated (e.g., highlighted, line shading, colored, etc.). For example, if a finger tip is over a region in field of view 210 that is mapped to the letter A, the camera captures the image, and the dongle 120 processes the captured image, maps the finger to the letter key, and provides to the microdisplay (or another display mechanism) an image for projection a highlighted (or illuminated) A key 1000. In some implementations, only a single key is highlighted (e.g., the last key detected by dongle 120), but other implementations include the illumination of adjacent keys that are partially covered by the fingertip.

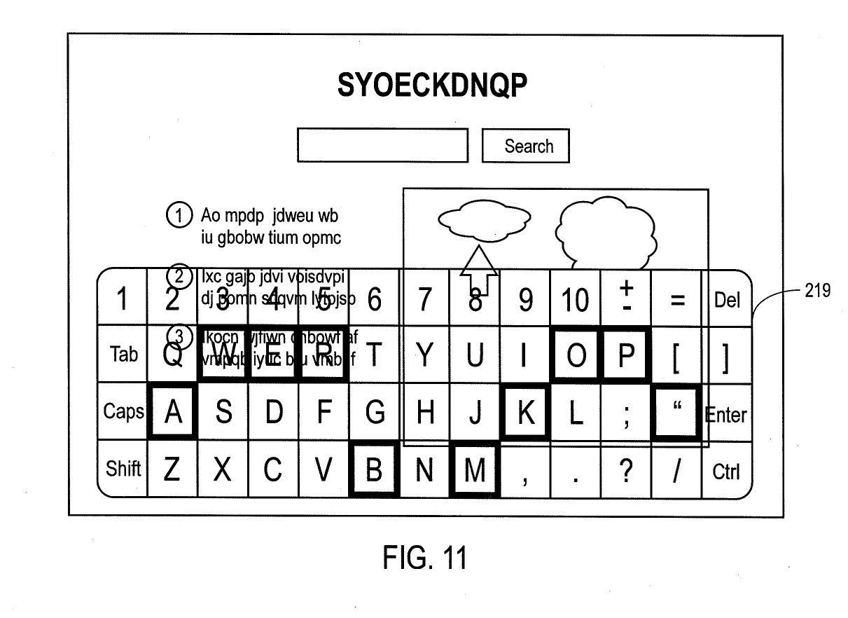

FIG. 11 is similar to FIG. 10, but FIG. 11 uses a different illumination scheme for the keys of the virtual keyboard 219. For example, the keys outlines are illuminated when fingertips are hovering over the corresponding regions in field of view 210 (regions mapped to the keys of the virtual keyboard 219, which is detected by the camera 122 and dongle 120). FIG. 11 depicts that the user's fingertips are hovering over regions (which are in the field of view 210 of camera 122) mapped to the keys A, W, E, R, B, M, K, O, P, and “.

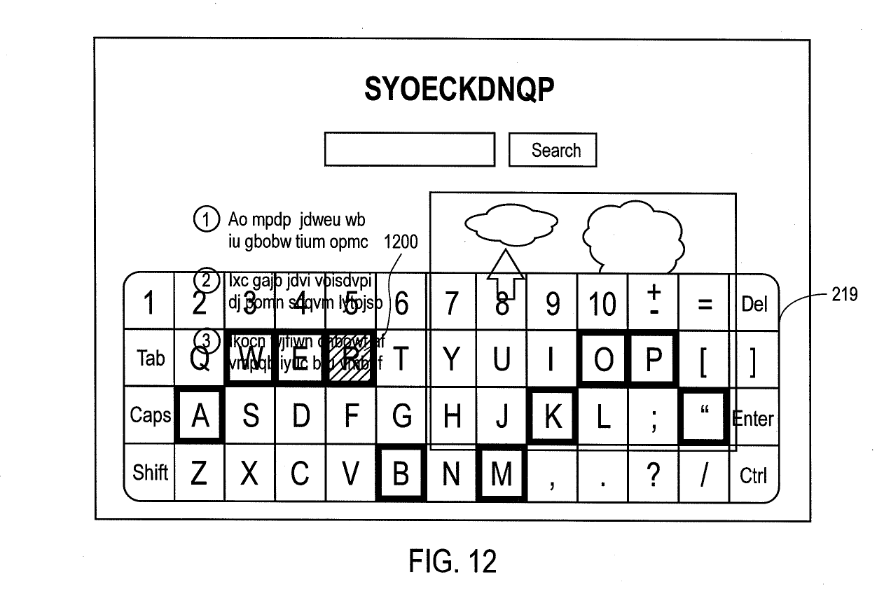

The virtual keyboard 219 of FIG. 12 is similar to the virtual keyboard 219 of FIG. 11, but adds the display of a key press that is illuminated as depicted at 1200. In the example of FIG. 12, when the a user taps a table in the region of the camera's field of view 210 that has been mapped to the key “R”, the image (which is presented by a microdisplay and/or another display mechanism) of the “R” key in the virtual keyboard 219 is briefly illuminated 1200 with, for example, a transparent color to signal to the user that the system 100 has detected the intended key press.

When a user sees a image of hands typing on the image of the virtual keyboard 219, and these images are stabilized by system 100 as the user head moves (e.g., the virtual key board 219 image and virtual monitor image 215) are stabilized for head movements). The keyboard sensing area (i.e., the field of view 210 with regions mapped to the keys of the keyboard) is also stabilized, so that the keyboard sensing area remains aligned with hand positions even when the head moves. To stabilize, the sensing area is stabilized relative to the table because it is sitting on the table rather than being attached to the user (see, e.g., FIG. 2). This is only the case if the camera is sitting on the table or some other stable surface. If we mount the camera to the front of a HMD, then the camera (and hence the keyboard sensing region) will move every time the user moves her head. In this case, the sensing area would not be world-stabilized.

The decoupling of the image of the keyboard from the physical location of the keyboard sensing area is analogous to the usage of a computer mouse. When using a mouse, a user does not look at his or her hands and the mouse in order to aim the mouse. Instead, the user views the virtual cursor that makes movements on the main screen which are correlated with the motions of the physical mouse. Similarly, the user would aim his or her fingers at the keys by viewing the video image of her fingertips or hands overlaid on the virtual keyboard 219 (which is the image projected on the user's eyes by the microdisplays 162A-B and/or another display mechanism).

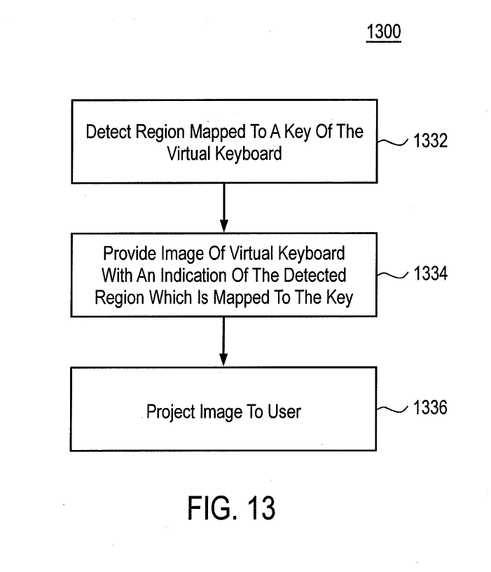

FIG. 13 depicts a process 1300 for using system 100. At 1332, system 100 detects regions in the field of view of the camera 122. These regions have each been mapped (e.g., by a processor included in dongle 120) to a key of a virtual keyboard 219. For example, image processing at dongle 120 may detect motion between images taken by camera 122. The detected motion may be identified as finger taps of a keyboard. At 1334, dongle 120 provides to microdisplays 162A-B an image of the virtual keyboard 219 including an indication of the detected key. At 1336, the microdisplays 162A-B projects the image of the virtual keyboard 219 and an indication of the detected key. Although the above examples described eyeglasses 160 including two microdisplays 162A-B, other quantities of microdisplays (e.g., one microdisplay) may be mounted on eyeglasses 160. Moreover, other display mechanism, as noted above, may be used to present the virtual fingers, virtual keyboard, and/or virtual monitor).

Although the above examples describe a virtual keyboard being projected and a user typing on a virtual keyboard, the system 100 may also be used to manipulate a virtual mouse (e.g., mouse movements, right clicks, left clicks, etc), a virtual touch pad, and other virtual input/output devices.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The foregoing description is intended to illustrate but not to limit the scope of the invention, which is defined by the scope of the appended claims. Other embodiments are within the scope of the following claims.

What is claimed:

1. A system comprising:
a processor configured to generate at least one image including a virtual keyboard; and
a display configured to project the at least one image received from the processor, the at least one image of the virtual keyboard including an indication representative of a finger selecting a key of the virtual keyboard.

2. The system of claim 1, wherein the display comprises at least one of a microdisplay, a high definition television, and a monitor.

3. The system of claim 1, wherein the at least one image includes the virtual keyboard and a virtual monitor.

4. The system of claim 1, wherein the processor provides the at least one image to a display comprising at least one of a microdisplay, a high definition television, and a monitor.

5. The system of claim 1 further comprising:
another processor configured to detect a movement of the finger and transform the detected movement into a selection of the virtual keyboard.

6. A method comprising:
generating at least one image including a virtual keyboard; and
providing the at least one image to a display, the at least one image comprising the virtual keyboard and an indication representative of a finger selecting a key of the virtual keyboard.

7. The method of claim 6, wherein the display comprises at least one of a microdisplay, a high definition television, and a monitor.

8. The method of claim 6, wherein the at least one image includes the virtual keyboard and a virtual monitor.

9. The method of claim 6, wherein the processor provides the at least one image to a display comprising at least one of a microdisplay, a high definition television, and a monitor.

10. The method of claim 6 further comprising:
detecting a movement of the finger; and
transforming the detected movement into a selection of the virtual keyboard.

11. A computer readable storage medium configured to provide, when executed by at least one processor, operations comprising:
generating at least one image including a virtual keyboard; and
providing the at least one image to a display, the at least one image comprising the virtual keyboard and an indication representative of a finger selecting a key of the virtual keyboard.

12. The computer readable storage medium of claim 11, wherein the display comprises at least one of a microdisplay, a high definition television, and a monitor.

13. The computer readable storage medium of claim 11, wherein the at least one image includes the virtual keyboard and a virtual monitor.

14. The computer readable storage medium of claim 11, wherein the processor provides the at least one image to a display comprising at least one of a microdisplay, a high definition television, and a monitor.

15. The computer readable storage medium of claim 11 further comprising:
detecting a movement of the finger; and
transforming the detected movement into a selection of the virtual keyboard.
